(19) United States
(12) Patent Application Publication
(10) Pub. No.: US 2023/0037692 A1
(43) Pub. Date: Feb. 9, 2023

(54) Static Authentication Questions for Account Authentication

(71) Applicant: Capital One Services, LLC, Mclean, VA (US)

(72) Inventors: Joshua Edwards, Philadelphia, PA (US); Viraj Chaudhary, Katy, TX (US); Tyler Maiman, Melville, NY (US); David Septimus, New York, NY (US); Daniel Miller, Astoria, NY (US); Samuel Rapowitz, Roswell, GA (US); Jenny Melendez, Falls Church, VA (US)

(21) Appl. No.: 17/392,400

(22) Filed: Aug. 3, 2021

(51) Int. Cl. G06Q 20/40; G06Q 20/38; G06F 21/31

(52) U.S. Cl. CPC G06Q 20/4016; G06Q 20/388; G06Q 20/4015; G06F 21/316

(57) ABSTRACT

Methods, systems, and apparatuses are described herein for improving computer authentication processes using static authentication questions with answers that change based on user account information. A request for access to an account may be received. A static question may be received. The static question may comprise one or more prompts and a plurality of different predetermined answers. Transaction data may be received. Based on the transaction data, a portion of the plurality of different predetermined answers may that correspond to correct answers may be determined. The question may be presented to a user, and a candidate response may be received. Access to the account may be provided based on the candidate response.

### FIELD OF USE

Aspects of the disclosure relate generally to account security. More specifically, aspects of the disclosure may provide for improvements in the method in which authentication questions are generated through the use of static authentication questions with correct answers that vary based on account information.

### BACKGROUND

As part of determining whether to grant a user access to content (e.g., as part of determining whether to provide a caller access to a telephone system that provides banking information), a user of the user device might be prompted with one or more authentication questions. Such questions might relate to, for example, a password of the user, a personal identification number (PIN) of the user, or the like. Those questions might additionally and/or alternatively be generated based on personal information of the user. For example, when setting up an account, a user might provide a variety of answers to predetermined questions (e.g., “Where was your father born?,” “Who was your best friend in high school?”), and those questions might be presented to the user as part of an authentication process. As another example, a commercially-available database of personal information might be queried to determine personal information for a user (e.g., their birthdate, birth location, etc.), and that information might be used to generate an authentication question (e.g., “Where were you born, and in what year?”). A potential downside of these types of authentication questions is that the correct answers may be obtainable and/or guessable for someone who has information about a particular user.

As part of authenticating a computing device, information about financial transactions conducted by a user of that computing device might be used to generate authentication questions as well. For example, a user might be asked questions about one or more transactions conducted by the user in the past (e.g., “Where did you get coffee yesterday?,” “How much did you spend on coffee yesterday?,” or the like). Such questions might prompt a user to provide a textual answer (e.g., by inputting an answer in a text field), to select one of a plurality of answers (e.g., select a single correct answer from a plurality of candidate answers), or the like. In some instances, the user might be asked about transactions that they did not conduct. For example, a computing device might generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user might be able to glean personal information about the legitimate user.

One risk in providing authentication questions based on financial transactions conducted by a user is that the questions might be guessable under certain circumstances. For example, if an account belongs to a public figure or someone that is well-known to a malicious user, that malicious user might be able to guess the answers to authentication questions. Moreover, a malicious user might be able to use authentication questions to glean information about a legitimate user and later use that information to answer authentication questions. For example, if the question “How much did you spend on coffee yesterday?” is presented, the malicious user might learn that an account owner regularly purchases coffee. Over time (e.g., by analyzing multiple such authentication questions), the malicious user might be able to learn about the account, thereby allowing them to potentially guess the answers to the authentication questions.

Aspects described herein may address these and other problems, and generally improve the safety of financial accounts and computer transaction systems by generating and using static authentication questions for use with a variety of different accounts.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to use of static authentication questions. As will be described in more detail below, a static authentication question might comprise a prompt and one or more predetermined answers which might be presented to a variety of different users (e.g., users trying to log into a variety of different accounts) and during a variety of different authentication processes. While a static question (including its prompt and answer options presented to the user) might not change from account to account, the correct answer to the static question (e.g., the particular one of the plurality of predetermined answers that is correct for a particular account) might change from user to user based on dynamic (and therefore more difficult to obtain and/or guess) information about the user, such as recent transaction data. In this manner, the static question need not provide any personally identifying information about an account, thereby preventing malicious users from gleaning personal information about the account, while still providing secure authentication by requiring answers that are difficult to obtain for anyone besides an authentic user.

More particularly, some aspects described herein may provide for a computing device that may receive, from a user device, a request for access to an account associated with a user. The computing device may receive, from a static questions database, a static question that comprises one or more prompts (e.g., “Where did you go for lunch last week?”) and a plurality of different predetermined answers corresponding to the one or more prompts (e.g., “Restaurant A,” “Restaurant B,” “Neither,” “Both”). The computing device may receive, from a transactions database, transactions data corresponding to the account. That transactions data may indicate one or more transactions conducted by the user. The computing device may determine, based on the transactions data, a portion (e.g., one or more) of the plurality of different predetermined answers that correspond to correct answers. For example, the transactions data might indicate an account was used to pay for lunch at Restaurant B last week, such that the predetermined answer “Restaurant B” is correct for the account. The computing device may cause presentation of the one or more prompts to the user. The computing device may receive a candidate response to the one or more prompts. The candidate response may indicate one or more of the plurality of different predetermined answers. The computing device may provide, based on comparing the candidate response to the portion of the plurality of different predetermined answers that correspond to correct answers, the user device access to the account.

According to some embodiments, the computing device may receive, from the transactions database, second transactions data corresponding to a second account. That second account may be associated with a second user. The computing device may then determine, based on the second transactions data, a second portion of the plurality of different predetermined answers that correspond to correct answers. The computing device may then cause presentation of the one or more prompts to the second user. The computing device may then receive a second candidate response to the one or more prompts and provide, based on comparing the second candidate response to the second portion of the plurality of different predetermined answers that correspond to correct answers, a second user device access to the second account. The computing device may receive the static question based on a likelihood that the request for access to an account is received from a malicious entity. The likelihood that the request for access to an account is received from a malicious entity may be based on one or more of: an Internet Protocol (IP) address associated with the request for access; or a geographical location associated with the request for access. The computing device may generate the static question by generating the one or more prompts, retrieving, from a merchants database, a plurality of different merchants based on a transaction volume corresponding to each of the plurality of different merchants, selecting, as the plurality of different predetermined answers, at least two of the plurality of different merchants, and storing, in the static questions database, the static question. The computing device may cause presentation of the one or more prompts to the user based on a determination that the one or more prompts were not presented to the user within a predetermined period of time. The computing device may provide the user device access to the account by causing the computing device to determine a first weight corresponding to a first predetermined answer of the plurality of different predetermined answers, determine a second weight corresponding to a first predetermined answer of the plurality of different predetermined answers, and generate a weighted candidate response by applying the first weight and the second weight to the candidate response; and determine whether the weighted candidate response satisfies a threshold.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for generating and presenting static authentication questions; and

FIG. 5 depicts examples of static authentication questions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving authentication questions used during an authentication process. In particular, the process depicted herein may use static authentication questions to improve the security of authentication questions by preventing malicious users from using authentication questions to acquire data about an account.

As an example of one problem addressed by the current disclosure, an authentication system might, as part of an authentication process for accessing an account, generate and present an authentication question, such as “How much did you spend on coffee yesterday?”. While this authentication question might be strong (in that, e.g., it might be hard for a malicious user to guess how much another person spent on coffee), this question can nonetheless be used to acquire information about a user (e.g., that they go to coffee shops). Over time (and, e.g., by analyzing multiple such authentication questions), a malicious user might be able to profile an account, thereby allowing them to guess information about the account that might allow them to better guess answers to authentication questions. For instance, a question such as “How much did you spend at [Luxury Brand] last month?” might suggest that an account is associated with an affluent user, allowing the malicious user to make inferences (e.g., that they spend more on coffee than the average person) that might allow them to better guess future authentication questions.

The static authentication questions discussed herein remedy these and other problems by presenting questions with prompts and predetermined answers that need not vary from user to user, though the correct answer (that is, the one of the predetermined answers that is correct) might vary from user to user, and might vary for a particular user based on time (e.g., because the question may be about a most recent transaction). For example, a static authentication question might ask “Where did you last get gas?,” with predetermined answers such as “Gas Station A,” “Gas Station B,” and “Neither of These.” That static authentication question (and the same predetermined answers) might be presented to two different users as part of two different authentication processes for access to entirely different accounts, though the correct answer to the static authentication question might be different for the different accounts. For example, the answer for Account A might be “Gas Station B,” whereas the answer for Account B might be “Gas Station A.” In this manner, a malicious user cannot glean any particular facts from this question: because the answer could be either gas station or neither gas station, the malicious user cannot even derive if the account is associated with gas station purchases in the first place. Moreover, even if the malicious user did manage to obtain the correct answer for a particular user (e.g., by keylogging the authentic user), the answer to the static authentication question might later change for that particular user.

Aspects described herein improve the functioning of computers by improving the way in which computers provide authentication questions and protect computer-implemented accounts. The speed and processing complexity of computing devices allows them to present more complicated authentications than ever before, which advantageously can improve the security of sensitive account information. That said, the algorithms with which authentication questions are generated can have security holes, which might render those authentication questions undesirably vulnerable to exploitation. Such exploitation can result in the illegitimate use and abuse of computer resources. The processes described herein improve this process by generating and presenting authentication questions which do not undesirably reveal sensitive account information, thereby improving the safety of authentication questions. Such steps cannot be performed by a user and/or via pen and paper at least because the problem is fundamentally rooted in computing processes, involves a significantly complex amount of data and word processing, and requires steps (e.g., authenticating computerized requests for access) which cannot be performed by a human being.

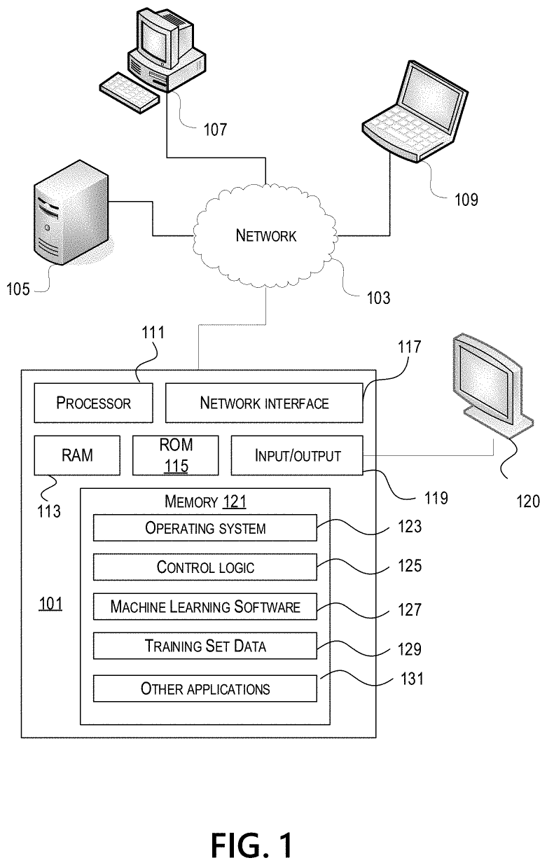

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

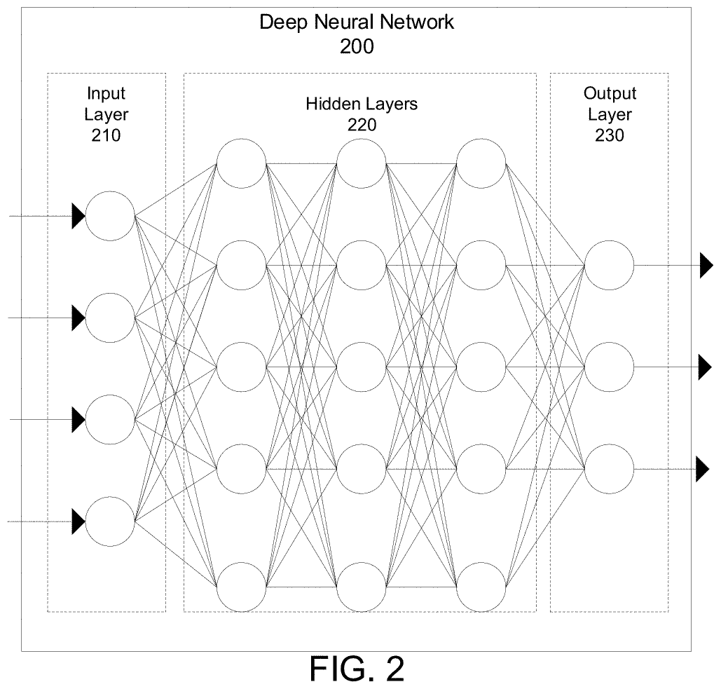

FIG. 2 illustrates an example deep neural network architecture 200. Such a deep neural network architecture might be all or portions of the machine learning software 127 shown in FIG. 1. That said, the architecture depicted in FIG. 2 need not be performed on a single computing device, and might be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

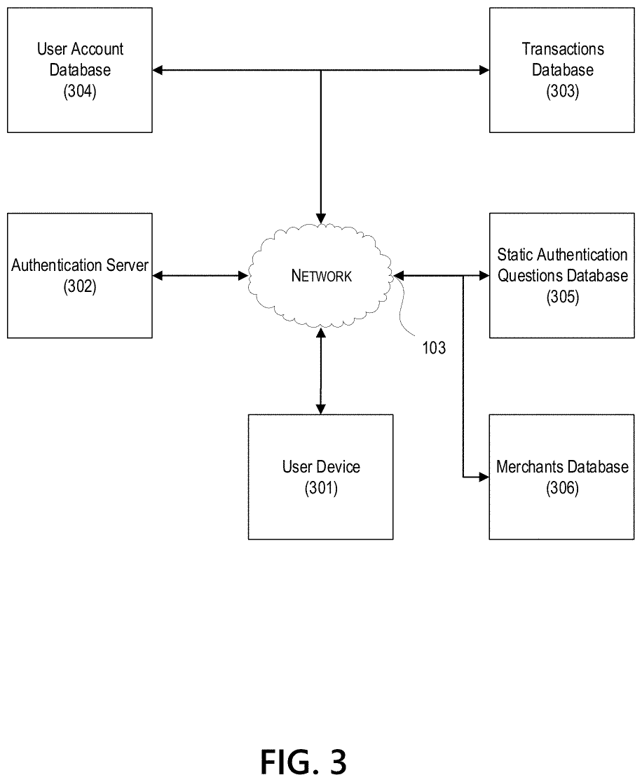

FIG. 3 depicts a system for authenticating a user device 301. The user device 301 is shown as connected, via the network 103, to an authentication server 302, a transactions database 303, a user account database 304, a static authentication questions database 305, and a merchants database 306. The network 103 may be the same or similar as the network 103 of FIG. 1. Each of the user device 301, the authentication server 302, the transactions database 303, the user account database 304, the static authentication questions database 305, and/or the merchants database 306 may be implemented on one or more computing devices, such as a computing device comprising one or more processors and memory storing instructions that, when executed by the one or more processors, perform one or more steps as described further herein. For example, any of those devices might be the same or similar as the computing devices 101, 105, 107, and 109 of FIG. 1.

As part of an authentication process, the user device 301 might communicate, via the network 103, to access the authentication server 302 to request access (e.g., to a user account). The user device 301 shown here might be a smartphone, laptop, or the like, and the nature of the communications between the two might be via the Internet, a phone call, or the like. For example, the user device 301 might access a website associated with the authentication server 302, and the user device 301 might provide (e.g., over the Internet and by filling out an online form) candidate authentication credentials to that website. The authentication server 302 may then determine whether the authentication credentials are valid. For example, the authentication server 302 might compare the candidate authentication credentials received from the user device 301 with authentication credentials stored by the user account database 304. In the case where the communication is telephonic, the user device 301 need not be a computing device, but might be, e.g., a conventional telephone.

The user account database 304 may store information about one or more user accounts, such as a username, password, demographic data about a user of the account, or the like. For example, as part of creating an account, a user might provide a username, a password, and/or one or more answers to predetermined authentication questions (e.g., “What is the name of your childhood dog?”), and this information might be stored by the user account database 304. The authentication server 302 might use this data to generate authentication questions. The user account database 304 might store demographic data about a user, such as their age, gender, location, occupation, education level, income level, and/or the like.

The transactions database 303 might comprise data relating to one or more transactions conducted by one or more financial accounts associated with a first organization. For example, the transactions database 303 might maintain all or portions of a general ledger for various financial accounts associated with one or more users at a particular financial institution. The data stored by the transactions database 303 may indicate one or more merchants (e.g., where funds were spent), an amount spent (e.g., in one or more currencies), a date and/or time (e.g., when funds were spent), or the like. The data stored by the transactions database 303 might be generated based on one or more transactions conducted by one or more users. For example, a new transaction entry might be stored in the transactions database 303 based on a user purchasing an item at a store online and/or in a physical store. As another example, a new transaction entry might be stored in the transactions database 303 based on a recurring charge (e.g., a subscription fee) being charged to a financial account. As will be described further below, synthetic transactions might be based, in whole or in part, on legitimate transactions reflected in data stored by the transactions database 303. In this way, the synthetic transactions might better emulate real transactions.

The account data stored by the user account database 304 and the transactions database 303 may, but need not be related. For example, the account data stored by the user account database 304 might correspond to a user account for a bank website, whereas the financial account data stored by the transactions database 303 might be for a variety of financial accounts (e.g., credit cards, checking accounts, savings accounts) managed by the bank. As such, a single user account might provide access to one or more different financial accounts, and the accounts need not be the same. For example, a user account might be identified by a username and/or password combination, whereas a financial account might be identified using a unique number or series of characters.

The static authentication questions database 305 may comprise data which enables the authentication server 302 to present authentication questions. An authentication question may be any question presented to one or more users to determine whether the user is authorized to access an account. For example, the question might be related to personal information about the user (e.g., as reflected by data stored in the user account database 304), might be related to past transactions of the user (e.g., as reflected by data stored by the transactions database 303), or the like. With respect to personal information, the question might relate to some aspect of the personal information of the user that might change (and might therefore be harder for a malicious entity to learn), such as their street address, where they currently work, or the like. With respect to past transactions of the user, the question might relate to recent transactions, such as those which might have been recently conducted by an authorized user but which might not yet be reflected in printed bank account statements (which might be stolen by a malicious entity).

The static authentication questions database 305 may comprise one or more static authentication questions. A static authentication question may comprise one or more prompts (e.g., “Which fast food restaurant did you eat at yesterday?”) and a plurality of different predetermined answers corresponding to the one or more prompts (e.g., “Restaurant A,” “Restaurant B,” “Restaurant C,” “None of the Above”). A static authentication question might be presented for different users such that the plurality of different predetermined answers presented to users might not change, though the one or more of the plurality of different predetermined answers that are correct might change. For example, for a first account, “Restaurant A” might be the correct answer to the aforementioned question, whereas, for a second account, both “Restaurant B” and “Restaurant C” might be correct answers to the same question. One advantage of the structure of this static authentication question is that a malicious user might not be able to glean personal information from the question: after all, the same question and the same predetermined answers might be presented whether or not the account was ever associated with a fast food purchase in the first place.

The static authentication questions database 305 might additionally and/or alternatively be used for dynamic authentication questions, such as questions dynamically generated for a particular authentication session and/or generated based on information corresponding to a particular account. The static authentication questions database 305 might comprise data for one or more templates which may be used to generate an authentication question based on real information (e.g., from the user account database 304 and/or the transactions database 303) and/or based on synthetic information (e.g., synthetic transactions which have been randomly generated and which do not reflect real transactions). An authentication question might correspond to a synthetic transaction (e.g., a transaction which never occurred). For example, a synthetic transaction indicating a $10 purchase at a coffee shop on Wednesday might be randomly generated, and the authentication question could be, e.g., “Where did you spent $10 last Wednesday?,” “How much did you spend at the coffee shop last Wednesday?,” or the like. In all such questions, the correct answer might indicate that the user never conducted the transaction. As part of generating authentication questions based on synthetic transactions, organizations might be randomly selected from a list of organizations stored by the merchants database 306. Additionally and/or alternatively, as part of generating such authentication questions based on synthetic transactions, real transactions (e.g., as stored in the transactions database 303) might be analyzed. In this manner, real transactions might be used to make synthetic transactions appear more realistic. The static authentication questions database 305 might additionally and/or alternatively comprise historical authentication questions. For example, the static authentication questions database 305 might comprise code that, when executed, randomly generates an authentication question, then stores that randomly-generated authentication question for use with other users.

As part of an authentication process, a combination of both static and dynamic questions might be used. The use of static authentication questions might be useful in that it might prevent malicious users from learning information about users. On the other hand, the use of dynamic questions might be useful in that they might be somewhat harder for a malicious user to guess, making the authentication process as a whole stronger. Mixing the two types of questions together might advantageously prevent malicious users from ascertaining which questions are static and which are dynamic, thereby preventing the malicious user from gleaning information about an account while simultaneously leveraging the security benefits of dynamic authentication questions.

The static and/or dynamic authentication questions stored in the static authentication questions database 305 may be associated with varying levels of difficulty. For example, straightforward answers that should be easily answered by a user (e.g., “What is your mother's maiden name?”) might be considered easy questions, whereas complicated answers that require a user to remember past transactions (e.g., “How much did you spend on coffee yesterday?”) might be considered difficult questions. An authentication process might prompt a user to answer multiple authentication questions. For example, a user might be required to correctly answer three easy authentication questions and/or to answer one hard authentication question.

The merchants database 306 might store data relating to one or more merchants, including indications (e.g., names) of merchants, aliases of the merchants, and the like. That data might be used to generate authentication questions that comprise both correct answers (e.g., based on data from the transactions database 303 indicating one or more merchants where a user has in fact conducted a transaction) and synthetic transactions (e.g., based on data from the merchants database 306, which might be randomly-selected merchants where a user has not conducted a transaction). For example, a computing device might, as part of randomly generating a synthetic transaction using instructions provided by the static authentication questions database 305, generate a synthetic transaction by querying the merchants database 306 for a list of merchants, then removing, from that list, organizations represented in the data stored by the transactions database 303.

Having discussed several examples of computing devices which may be used to implement some aspects as discussed further below, discussion will now turn to a method for using static authentication questions during an authentication process.

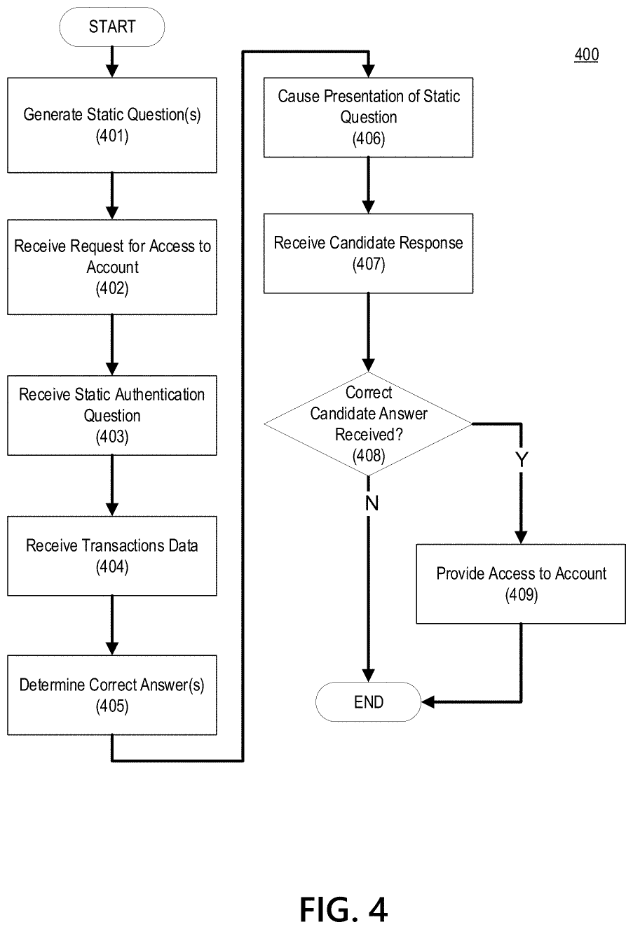

FIG. 4 illustrates an example method 400 for generating and presenting static authentication questions in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged or otherwise modified as desired.

In step 401, a computing device may generate one or more static authentication questions. Static authentication questions might be generated for a plurality of different accounts, and in a manner such that the static authentication questions may be used during various different authentication processes. For example, the computing device may generate the static question by generating one or more prompts. Such prompts may be questions, such as “Where did you buy fuel from last week?” The computing device may retrieve, from a merchants database (e.g., the merchants database 306), a plurality of different merchants based on a transaction volume corresponding to each of the plurality of different merchants. In this manner, the computing device might select a most common and/or most popular merchant for inclusion as a potential answer and/or for inclusion as part of a prompt. The merchant(s) selected might correspond to a particular geographic region. For example, the plurality of different merchants might comprise the top five gas stations in a particular geographic region. As another example, a popular local merchant might be selected for inclusion in a static authentication question prompt. The computing device may then select, as the plurality of different predetermined answers, at least two of the plurality of different merchants. For example, the computing device might randomly select two of the plurality of different merchants for inclusion as possible answers to the one or more prompts. In addition to such merchants, other answers (e.g., “Neither,” “Both,” etc.) might be selected. The computing device may then store, in the static questions database (e.g., the static authentication questions database 305), the static question. As such, the static authentication question might have a prompt that asks “Where did you buy fuel from last week?” with possible answers “Merchant A,” “Merchant B,” “Neither,” “Both,” and the like. This process might be performed for a single static authentication question or a plurality of different static authentication questions.

In step 402, the computing device may receive a request for access to an account. For example, the computing device may receive, from a user device, a request for access to an account associated with a user. The request may be associated with access, by a user, to a website, an application, or the like. The request may additionally and/or alternatively be associated with, for example, a user device calling into an IVR system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user might call an IVR system and be identified (e.g., using caller ID) by their telephone number, which might be used to query the user account database 304 for a corresponding account.

In step 403, the computing device may receive a static authentication question. The computing device might receive a static authentication question by selecting (e.g., requesting and retrieving) a static authentication question of one or more static authentication questions stored by the static authentication questions database 305. For example, the computing device may receive, from a static questions database (e.g., the static authentication questions database 305), a static question that comprises one or more prompts and a plurality of different predetermined answers corresponding to the one or more prompts. The static authentication question might be selected at random (e.g., randomly selected from one of a plurality of different static authentication questions stored by the static authentication questions database). Additionally and/or alternatively, the static authentication question might be selected based on geographic location (e.g., so that the answers correspond to locally popular merchants). The static authentication question might be additionally and/or alternatively selected based on whether the static authentication question has been recently presented to a user. For example, a static authentication question might be shown if it has not been shown to a user (and/or for an account) for a predetermined time period. In this manner, the computing device avoids selecting (and presenting) the same static authentication question multiple times over a time period, which might suggest to a malicious user that the static authentication question is static (and which might give the malicious user another opportunity to guess the answer to the question).

The static question might be received based on a likelihood that the request for access to an account is associated with unusual activity, such as activity by a malicious entity. Static authentication questions might be retrieved (and, as will be detailed later, presented) based on a detection that a request for access to an account may be associated with a malicious entity, such as a potential hacker. In this manner, in response to unusual activity, the computing device can protect account information by presenting authentication questions that do not divulge information about an account. The likelihood that the request for access to an account is received from a malicious entity may be based on an Internet Protocol (IP) address associated with the request for access. For example, if the request originates from an IP address outside of a geographical region associated with an account, the request might be associated with a malicious entity. As another example, if the request originates from an IP address range known for malicious activity (e.g., an IP address range associated with hacking activity), the request might be associated with a malicious entity. The likelihood that the request for access to an account is received from a malicious entity may be additionally and/or alternatively based on a geographical location associated with the request for access. For example, if the request originates from a computing device located in a first geographical location that is outside of a geographical region associated with an account, the request might be associated with a malicious entity.

In step 404, the computing device may receive transactions data. The transaction data may be received from, e.g., the transactions database 303. The transaction data might correspond to the account referenced in step 402. For example, the computing device may receive, from a transactions database, transactions data corresponding to the account. The transactions data may indicate one or more transactions conducted by the user. For example, the transactions data may comprise indications of purchases of goods and/or services made by a user. The transactions data might correspond to a period of time, such as a recent period of time (e.g., the last two months, the last four months, or the like).

In step 405, the computing device may determine correct answer(s) to the static authentication question. As indicated above, a static authentication question may comprise a plurality of different predetermined answers. These predetermined answers need not change, but one or more of the plurality of different predetermined answers might be correct for a particular account. To determine which of the one or more of the plurality of different predetermined answers might be correct, the computing device might compare each of the plurality of different predetermined answers to the transactions data received in step 404. For example, the computing device may determine, based on the transactions data, a portion of the plurality of different predetermined answers that correspond to correct answers.

As one example of how correct answers might be determined as part of step 405, a static authentication question might have a prompt that asks “Where did you buy fuel from last week?” with possible answers “Merchant A,” “Merchant B,” “Neither,” and “Both.” The transactions data received in step 404 might indicate that, last week, the account was used for a variety of transactions, including one gas purchase at Merchant B. Accordingly, as part of step 405, it might be determined that the correct answer to the static authentication question is “Merchant B” and not “Merchant A,” “Neither,” or “Both.”

In step 406, the computing device may cause presentation of the static authentication question. For example, the computing device may cause presentation of the one or more prompts to the user. Causing presentation of the static authentication question may comprise causing one or more computing devices to display and/or otherwise output the static authentication question. The authentication question might be provided in a text format (e.g., in text on a website), in an audio format (e.g., over a telephone call), or the like.

The static authentication question might only be presented such that it is not repeated or otherwise detectable as a static authentication question. The static authentication questions database 305 might maintain indications of, for example, the last time a static authentication question was presented to a user, a number of times that a static authentication question was presented, or the like. Using this data, the computing device may be configured to prevent a static authentication question to be repeated for the same account and/or similar accounts. For example, the computing device may cause presentation of the static authentication question based on a determination that the one or more prompts were not presented to the user within a predetermined period of time. Such a predetermined period of time might be, for example, a month, a year, or the like. If the data stored by the static authentication questions database 305 indicates that a static authentication question has been used recently (e.g., shown to the user recently, such as within the last month), the method 400 might return to step 403, where the computing device might request and/or retrieve a new static authentication question.

In step 407, the computing device may receive a candidate response to the static authentication question. A candidate response may be any indication of a response, by a user, to the static authentication question presented in step 406. For example, the computing device may receive a candidate response to the one or more prompts, wherein the candidate response indicates one or more of the plurality of different predetermined answers. For example, where a static authentication question comprises one or more predetermined answers, the candidate response might comprise a selection of at least one of the one or more predetermined answers. As another example, in the case of a telephone call, the candidate response might comprise an oral response to a static authentication question provided using a text-to-speech system over the call.

In step 408, the computing device may determine whether the candidate response received is correct. Determining whether the candidate response is correct may comprise comparing the candidate response to the correct answer(s) determined in step 405. If the candidate answer is incorrect, the method 400 ends. Otherwise, the method 400 proceeds to step 409.

In step 409, the computing device may provide access to the account. For example, the computing device may provide, based on comparing the candidate response to the portion of the plurality of different predetermined answers that correspond to correct answers, the user device access to the account. Access to the account might be provided by, e.g., providing a user device access to a protected portion of a website, transmitting confidential data to a user device, allowing a user to request, modify, and/or receive personal data (e.g., from the user account database 304 and/or the transactions database 303), or the like.

Determining whether to provide and/or providing the user access to the account (e.g., steps 408 and 409, above) might be based on weighting the candidate response received in step 407. During authentication of an account, more than one of the predetermined answers for a static authentication question might be correct. For example, a static authentication question might have a prompt that asks “Where did you buy fuel from last week?” with possible answers “Merchant A,” “Merchant B,” “Neither,” and “Both.” In that example, the transactions data received in step 404 might indicate that, last week, the account was associated with fuel purchase transactions at both Merchant A and Merchant B. In such a circumstance, the answer “Merchant A” might be partially correct, and the answer “Merchant B” might be partially correct, but the answer “Both” might arguably be the most correct. In this circumstance, these answers might be weighted differently. The computing device may determine a first weight corresponding to a first predetermined answer of the plurality of different predetermined answers. For example, the answers “Merchant A” and “Merchant B” might both be weighted by a factor of 0.5, as both are arguably half correct. The computing device may then determine a second weight corresponding to a first predetermined answer of the plurality of different predetermined answers. For example, the answer “Both” might be weighted by a factor of 1.5, as the answer is arguably the most correct, and bonus weight might be awarded on that basis. Then, the computing device may generate a weighted candidate response by applying the first weight and the second weight to the candidate response and determine whether the weighted candidate response satisfies a threshold. This weighting might be used to determine if access to an account should be provided or if further authentication questions should be presented to the user. If the weighted candidate response fails to satisfy the threshold, another authentication question might be presented. For example, if the user answers “Merchant A,” their answer might be discounted by 50%, and thus the user might be asked another authentication question as part of an authentication process. As another example, and in contrast, if the user answered “Both,” the user might be provided access to the account without being presented with more authentication questions.

The process depicted as part of the method 400 may be repeated for a different account such that the correct answers might be different in whole or in part. As described above, one advantage of a static authentication question is that it might appear substantially the same during authentication processes for entirely different accounts. As such, the same authentication questions (e.g., with the same and/or similar prompts and the same and/or similar predetermined answers) might be used in different authentication processes. For example, as part of a different request for access to a second account, the computing device may receive, from the transactions database, second transactions data corresponding to the second account. This step may be the same or similar as step 404, albeit with respect to a different account. That second account may be associated with a second user. The computing device may then determine, based on the second transactions data, a second portion of the plurality of different predetermined answers that correspond to correct answers. This step may be the same or similar as step 405 of FIG. 4, albeit with respect to the second account. In this way, the correct answers for the second account might be entirely or partially different than those for the account discussed with respect to step 405 of FIG. 4. The computing device may then cause presentation of the one or more prompts to the second user. This step may be the same or similar as step 406 of FIG. 4. The computing device may then receive a second candidate response to the one or more prompts. This step may be the same or similar as step 407 of FIG. 4. The computing device may then provide, based on comparing the second candidate response to the second portion of the plurality of different predetermined answers that correspond to correct answers, a second user device access to the second account. This step may be the same or similar as steps 408-409 of FIG. 4.

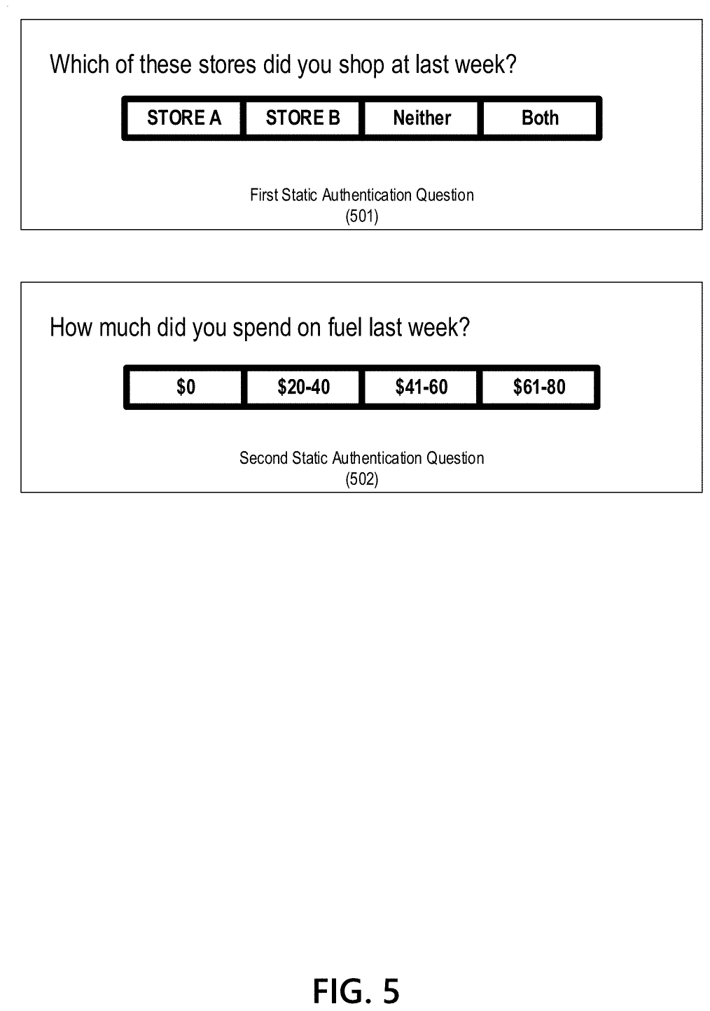

FIG. 5 depicts two examples of static authentication questions. The static authentication questions shown in FIG. 5 may have been generated as part of step 401 of FIG. 4, and may represent questions which might be asked of different users and in different authentication processes. That said, as indicated above, though the questions (and predetermined answers) might be the same, the correct answers to the questions depicted in FIG. 5 might differ from account to account.

A first static authentication question 501 comprises a prompt (“Which of these stores did you shop at last week?”) and a plurality of different predetermined answers corresponding to the one or more prompts (“Store A,” “Store B,” “Neither,” “Both”). A second static authentication question 502 comprises a prompt (“How much did you spend on fuel last week?”) and a plurality of different predetermined answers corresponding to the one or more prompts (“$0,” “$20-40,” “$41-60,” and “$61-80”). One advantageous strategy used by these static authentication questions is that they do not indicate whether an account has been used to shop at any stores. For example, the first static authentication question 501 could be used for an account whether or not it shopped at Store A or Store B. As another example, the second static authentication question 502 could be used for an account whether or not it had ever been used to purchase fuel. In this manner, the static authentication questions do not provide malicious users any potentially personal information about an account.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing device comprising:
one or more processors; and
memory storing instructions that, when executed by the one or more processors, cause the one or more processors to perform the steps of:
generating a static question for use in authenticating a plurality of different users by:
generating one or more prompts for the static question;
retrieving, from a merchants database, a plurality of different merchants based on a transaction volume corresponding to each of the plurality of different merchants; and
selecting, as a plurality of different answers for the one or more prompts for the static question, at least two of the plurality of different merchants;
receiving, from a user device and after generating the static question, a request that comprises data associated with an account associated with a user;
determining, based on an Internet Protocol (IP) address associated with the request, that the request is associated with unusual activity; and
in response to the determining that the request is associated with unusual activity:
receiving from a static questions database, the static question;
causing the user device to output, the static question and the plurality of different answers by sending, over a network and to the user device, the static question and the plurality of different answers:
receiving, from a transactions database, transactions data corresponding to the account, wherein the transactions data comprises information corresponding to one or more transactions conducted by the user;
determining, based on the transactions data, one or more of the plurality of different answers of the static question that correspond to correct answers for the user;
receiving, from the user device, a candidate response to the one or more prompts, wherein the candidate response comprises information corresponding to at least one of the plurality of different answers;
authenticating, based on comparing the candidate response to the one or more of the plurality of different answers that correspond to correct answers for the user, the user; and
providing, based on authenticating the user, the user device access to the account,

2. The computing device of claim 1, wherein the instructions, when executed by the one or more processors, further cause the one or more processors to perform the steps of:
receiving, from the transactions database, second transactions data corresponding to a second account, wherein the second account is associated with a second user;
determining, based on the second transactions data, a different one or more of the plurality of different answers that correspond to correct answers for the second user;
receiving, a second candidate response to the one or more prompts; and
providing, based on comparing the second candidate response to the different one or more of the plurality of different answers that correspond to correct answers for the second user, a second user device access to the second account.

3. The computing device of claim 1, wherein the instructions, when executed by the one or more processors, further cause the one or more processors to perform the step of receiving the static question based receiving the request from a malicious entity.

4. The computing device of claim 3, wherein the instructions, when executed by the one or more processors cause the one or more processors to perform the step of:
determining, that the request was received from the malicious entity based on one or more of:
an Internet Protocol (IP) address associated with the request; or
a geographical location associated with the request.

5. The computing device of claim 1, wherein the instructions, when executed by the one or more processors, further cause the one or more processors to perform the steps of:
store, in the static questions database, the static question.

6. The computing device of claim 1, wherein the one or more prompts comprise a question regarding shopping activity at the at least two of the plurality of different merchants.

7. The computing device of claim 1, wherein the instructions, when executed by the one or more processors, further cause the one or more processors to perform the step of providing the user device access to the account by causing the one or more processors to perform the steps of:
determining a first weight corresponding to a first answer of the plurality of different answers;
determining a second weight corresponding to a first answer of the plurality of different answers;
generating a weighted candidate response by applying the first weight and the second weight to the candidate response; and
providing the user device access to the account based on comparing the weighted candidate response to a threshold.

8. A method comprising:
generating, by a computing device, a static question for use in authenticating a plurality of different users by:
generating, by the computing device, one or more prompts for the static question;
retrieving, by the computing device and from a merchants database, a plurality of different merchants based on a transaction volume corresponding to each of the plurality of different merchants; and
selecting, by the computing device and as a plurality of different answers for the one or more prompts for the static question, at least two of the plurality of different merchants;
receiving, by the computing device, from a user device, and after generating the static question, a request that comprises data associated with an account associated with a user;
determining, by the computing device and based on an Internet Protocol (IP) address associated with the request, that the request is associated with unusual activity; and
in response to the determining that the request is associated with unusual activity:
receiving, by the computing device and from a static questions database, the static question;
causing, by the computing device, the user device to output the static question and the plurality of different answers by sending, over a network and to the user device, the static question and the plurality of different answers:
receiving, by the computing device and from a transactions database, transactions data corresponding to the account, wherein the transactions data comprises information corresponding to one or more transactions conducted by the user;
determining, by the computing device and based on the transactions data, one or more of the plurality of different answers of the static question that correspond to correct answers for the user;
receiving, by the computing device and from the user device, a candidate response to the one or more prompts, wherein the candidate response comprises information corresponding to at least one of the plurality of different answers;
authenticating, by the computing device and based on comparing the candidate response to the one or more of the plurality of different answers that correspond to correct answers for the user, the user; and
providing, by the computing device and based on authenticating the user, the user device access to the account.

9. The method of claim 8, further comprising:
receiving, by the computing device and from the transactions database, second transactions data corresponding to a second account, wherein the second account is associated with a second user;
determining, by the computing device and based on the second transactions data, a different one or more of the plurality of different answers that correspond to correct answers for the second user;
receiving, by the computing device, a second candidate response to the one or more prompts; and
providing, by the computing device and based on comparing the second candidate response to the different one or more of the plurality of different answers that correspond to correct answers for the second user, a second user device access to the second account.

10. The method of claim 8, wherein selecting the static question is based on receiving the request from a malicious entity.

11. The method of claim 10, further comprising:
determining that the request was received from the malicious entity based on one or more of:
an Internet Protocol (IP) address associated with the request; or
a geographical location associated with the request.

12. The method of claim 8, further comprising:
storing, by the computing device and in the static questions database, the static question.

13. The method of claim 8, wherein the one or more prompts comprise a question regarding shopping activity at the at least two of the plurality of different merchants.

14. The method of claim 8, wherein providing the user device access to the account comprises:
determining, by the computing device, a first weight corresponding to a first answer of the plurality of different answers;
determining, by the computing device, a second weight corresponding to a first answer of the plurality of different answers;
generating, by the computing device, a weighted candidate response by applying the first weight and the second weight to the candidate response; and
providing, by the computing device, the user device access to the account based on comparing the weighted candidate response to a threshold.

15. One or more non-transitory computer-readable media storing instructions that, when executed by one or more processors of a computing device, cause the one or more processors to perform the steps of:
generating a static question for use in authenticating a plurality of different users by:
generating one or more prompts for the static question;
retrieving, from a merchants database, a plurality of different merchants based on a transaction volume corresponding to each of the plurality of different merchants; and
selecting, as a plurality of different answers for the one or more prompts for the static question, at least two of the plurality of different merchants;
receiving, from a user device and after generating the static question, a request that comprises data associated with an account associated with a user;
determining, based on an Internet Protocol (IP) address associated with the request, that the request is associated with unusual activity; and
in response to the determining that the request is associated with unusual activity:
receiving, from a static questions database, the static question;
causing, the user device to output the static question and the plurality of different answers by sending, over a network and to the user device, the static question and the plurality of different answers:
receiving, from a transactions database, transactions data corresponding to the account, wherein the transactions data comprises information corresponding to one or more transactions conducted by the user;
determining, based on the transactions data, one or more of the plurality of different answers of the static question that correspond to correct answers for the user;
receiving, from the user device, a candidate response to the one or more prompts, wherein the candidate response comprises information corresponding to at least one of the plurality of different answers;
authenticating, based on comparing the candidate response to the one or more of the plurality of different answers that correspond to correct answers for the user, the user; and
providing, based on authenticating the user, the user device access to the account.

16. The non-transitory computer-readable media of claim 15, wherein the instructions, when executed by the one or more processors, further cause the one or more processors to perform the steps of:
receiving, from the transactions database, second transactions data corresponding to a second account, wherein the second account is associated with a second user;
determining, based on the second transactions data, a different one or more of the plurality of different answers that correspond to correct answers for the second user;
receiving, a second candidate response to the one or more prompts; and
providing, based on comparing the second candidate response to the different one or more of the plurality of different answers that correspond to correct answers for the second user, a second user device access to the second account.

17. The non-transitory computer-readable media of claim 15, wherein the instructions, when executed by the one or more processors, further cause the one or more processors to perform the step of receiving the static question based on whether the request was received from a malicious entity.

18. The non-transitory computer-readable media of claim 17, wherein the instructions, when executed by the one or more processors, cause the one or more processors to perform the step of:
determining, that the request was received from the malicious entity based on one or more of:
an Internet Protocol (IP) address associated with the request; or
a geographical location associated with the request.

19. The non-transitory computer-readable media of claim 15, wherein the instructions, when executed by the one or more processors, further cause the one or more processors to perform the step of:
storing, in the static questions database, the static question.

20. The non-transitory computer-readable media of claim 15, wherein the one or more prompts comprise a question regarding shopping activity at the at least two of the plurality of different merchants.
